(19) United States
(12) Patent Application Publication
(10) Pub. No.: US 2021/0316666 A1
(43) Pub. Date: Oct. 14, 2021

(54) ADJUSTABLE MODULAR EQUIPMENT CARRYING DEVICE

(71) Applicant: Elaine Arterburn, Boise, ID (US)

(72) Inventor: Elaine Arterburn, Boise, ID (US)

(21) Appl. No.: 17/355,062

(22) Filed: Jun. 22, 2021

Related U.S. Application Data
(63) Continuation of application No. 16/602,301, filed on Sep. 5, 2019.
(60) Provisional application No. 62/765,667, filed on Sep. 6, 2018.

(51) Int. Cl. B60R 7/08; B60R 7/04

(52) U.S. Cl. CPC B60R 7/08; B60R 7/04

(57) ABSTRACT

The invention herein relates to a customizable carrying device. The carrying device has at least one flexible panel member with a front side and a back side. The front side is configured with pockets for the storage of items. The pockets may come in the form of an open pocket or a zippered pocket. There may be only one pocket or a plurality of varying pockets. The back side is configured with a coupling feature, such as hook and loop fasteners. The coupling feature of the back side extends across the back thereof. The carrying device comes with one or more flexible straps. The straps are configured such that proximate to each end is a connector feature. The straps may be used to attach one panel member to another panel member such that a saddle bag assembly is created.

### PRIORITY/CROSS-REFERENCE TO RELATED APPLICATIONS

This application is a continuation application and claims the benefit of U.S. Non-Provision application Ser. No. 16/602,301 filed Sep. 5, 2019, which claims the benefit of U.S. Provisional Application No. 62/765,667, filed Sep. 6, 2018, the disclosures of which are incorporated herein by reference.

### TECHNICAL FIELD

The presently disclosed technology relates to a carrying device. More particularly, the embodiments of the present invention is a carrying device that is customizable and adjustable.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The inventive concepts described herein relate to an adjustable modular carrying device, preferably that can be formed as a saddle bag. The modular carrying device has at least one flexible panel member, and two opposing flexible panel members when arranged as a saddle bag. The flexible panel members have a front and a back side. The panel members are configured with one or more compartments for storage of items. In one embodiment, the compartment is positioned on the front side of the panel members. The front side may have at least one compartment. In an alternative embodiment, the front side has a plurality of compartments. The compartment (or compartments) may be an open pouch. Alternatively, the compartment (or compartments) may be a zippered compartment.

The back side of each panel has a defined first end and a defined second end. The back also has a defined top end and defined bottom end. The back side has a coupling feature that extends between the first end and second end thereof. In one embodiment, the back side is an elongate rectangular shape. The coupling feature may span the entire distance between the first and second end.

The modular carrying device includes at least one flexible strap. The modular carrying device may have two straps. In one embodiment, two opposing panel members may be connected by two straps. The strap is configured with connectors proximate to each end of the strap. The connectors are configured to removably attach the flexible strap to the coupling features of the back side. The connectors extend between a first connector end and a second connector end of the strap at either end of the strap. Preferably, the connectors are hook and loop fasteners.

Preferably, a strip of hook and loop fasteners is used. The strip can be full length and/or width of the back side of the panel members. Alternatively, the coupling feature may span a distance less than the full length and/or width of the back side of the panel member. The flexible strap is configured to be removably attached to the back side via hook and loop fasteners positioned proximately at the ends thereof.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a front perspective view of an example of the modular carrying device.

FIG. 2 is front perspective view of a modular carrying device with an alternate pocket configuration.

FIG. 3 is a perspective view of a modular carrying device with a first panel member having a zippered pocket and attached to a second opposing panel member.

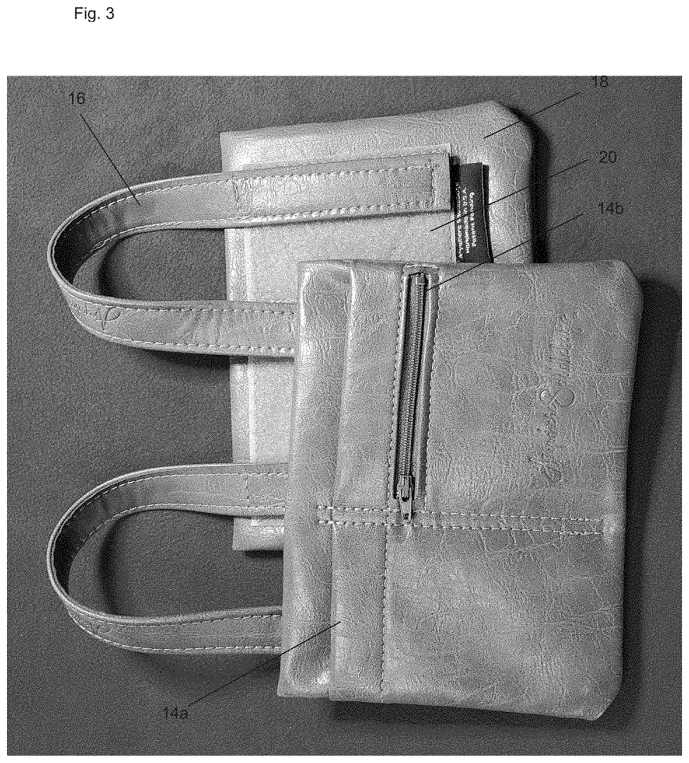

FIG. 4 is a perspective view showing a modular carrying device in a saddle bag configuration.

FIG. 5 is a perspective view of the back side of a modular carrying device with only one panel member and the straps connected in a looped configuration.

FIG. 6 is a perspective view of a modular carrying device showing two straps connected to opposing panel members in an X configuration.

FIG. 7 is a rear perspective view of a modular carrying device showing the back sides of two panel members with the straps placed in an extended configuration.

FIG. 8 is a rear perspective view of a modular carrying device showing two panel members connected by two straps.

FIG. 9 is a rear perspective view of a modular carrying device showing two panel members connected by two straps in a narrowed configuration.

FIG. 10 is a front perspective view of a modular carrying device having one panel member as attached to the arm of a chair.

FIG. 11 is a rear perspective view of a modular carrying device having a single panel member as attached to the arm of a chair.

FIG. 12 is a side perspective view of a modular carry device having on panel member as attached to the arm of a chair.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

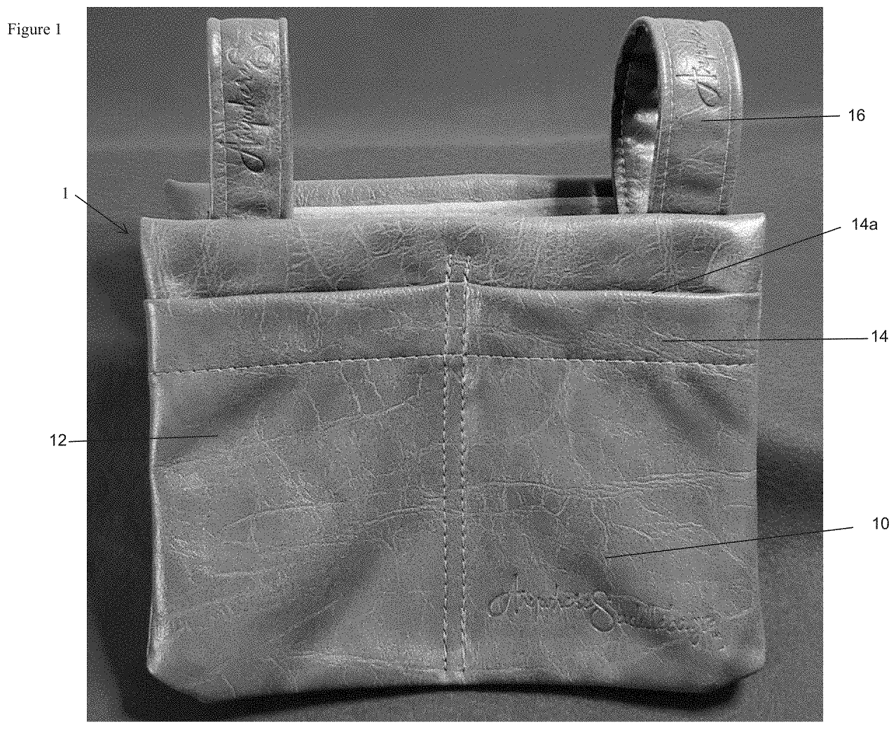

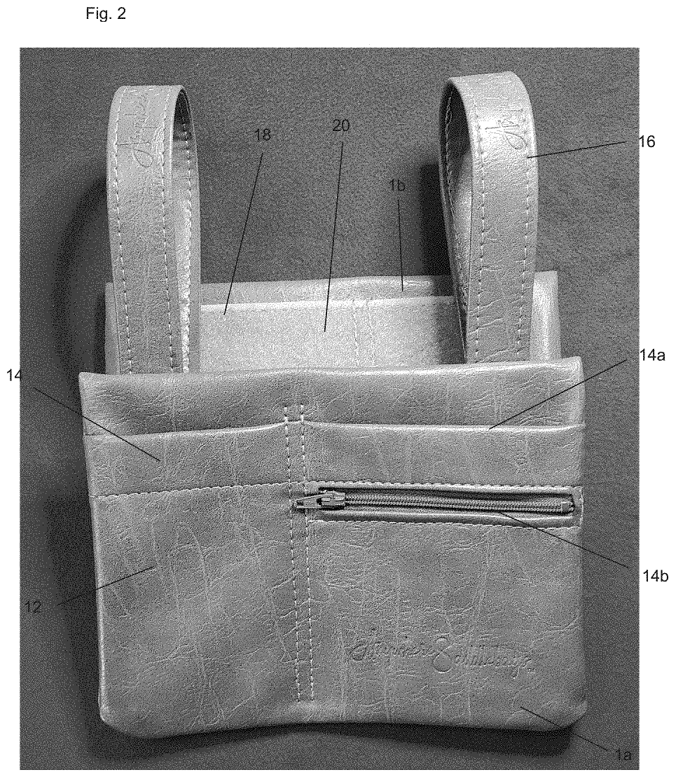

FIG. 1 depicts a front perspective view of the adjustable modular carrying device 1. The modular carrying device 1 has at least one panel member 10. The panel member 10 is made of a flexible material. The panel member 10 has a front side 12. The panel member 10 is configured with at least one pocket 14. In one embodiment, the front side 12 of the panel member 10 is configured with at least one pocket 14. The pockets 14 are configured for the storage of items. The front side 12 of the panel member 10 may be configured with a plurality of pockets 14. FIG. 1 depicts the pockets 14 as open pockets 14a. Alternatively, as shown in FIG. 2, the pockets 14 may be configured as zippered pockets 14b. The carrying device 1 has at least one flexible strap 16. FIG. 1 depicts the carrying device 1 with two straps 16. The strap 16 may be used to attach a first carrying device 1a to a second carrying device 1b.

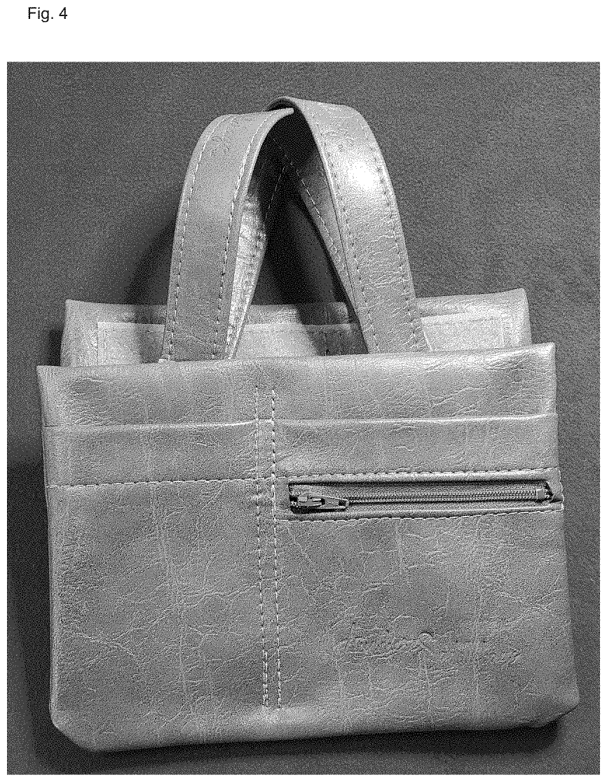

The panel member 10 has a back side 18. The back side 18 is configured with a coupling feature 20. The coupling feature 20 of the back side 18 is configured to attach at least one strap 16 of the carrying device 1. The strap 16 is configured to be removably attached to the coupling feature 20 of the back side. FIG. 4 depicts the straps 16 of the modular carrying device 1 in a crossed configuration. The coupling feature 20 of the back side 18 allows a user to vary the placement of the straps 16 thereon.

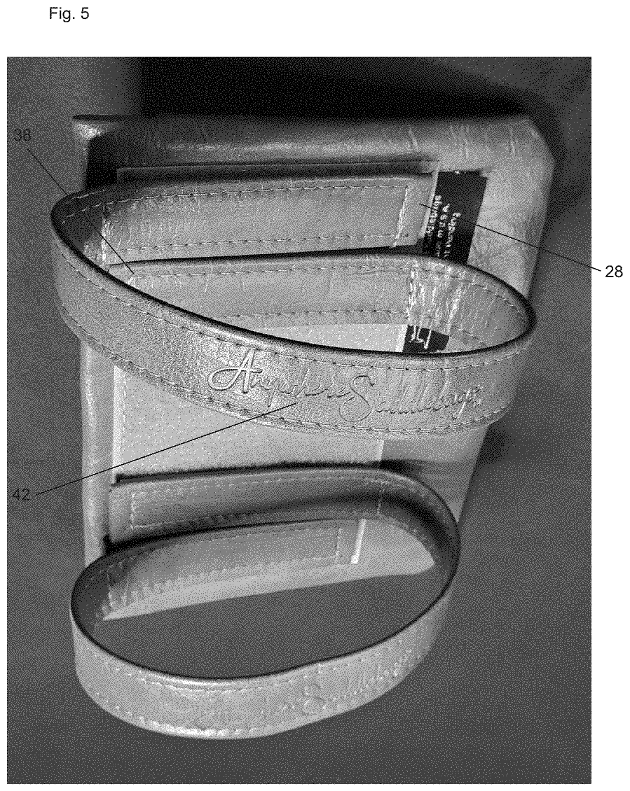

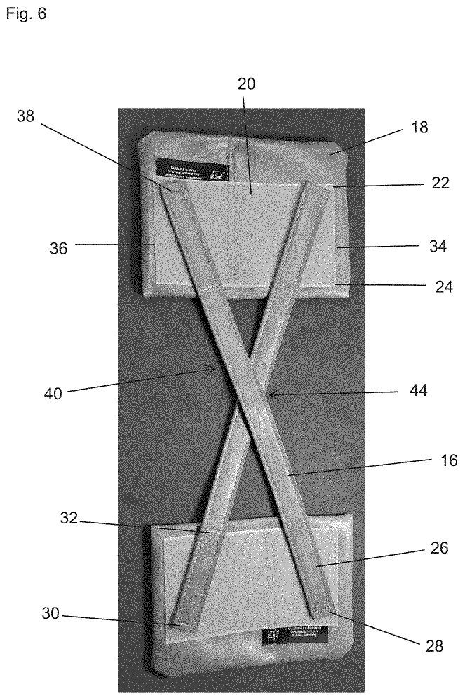

FIG. 5 depicts an embodiment of the modular carrying device 1 where the straps 16 are attached to a single panel member 10 in a looped 42 fashion. The loop 42 can be created when the first end 28 and second 38 of the strap are attached to the same coupling feature 20 of the same back side 18. FIG. 6 depicts the back side 18 of two panel members 10 where the straps 16 are in an X 44 configuration. In use, this configuration would resemble the depiction of FIG. 4.

FIG. 6 depicts the back side 18 having a top end 22 and a bottom end 24. The coupling feature 20 is configured to extend between the top end 22 and bottom end 24. The back side 18 has a first end 34 and a second end 36. The coupling feature 20 is configured to extend between the first end 34 and the second end 36. In one embodiment, the first end 34 and second end 36 are in the shape of an elongate rectangle.

The strap 16 has a first end 28 and a second end 38. The strap 16 extends a length 40 between the first end 28 and the second end 38. The strap 16 has connectors 26 proximate to each end 28, 38 of the strap 16. The connectors 26 of the strap 16 are configured to attach to the coupling feature 20 of the back side 18. For example, the connectors 26 of the strap 16 and the coupling feature 20 of the back side 18 may be corresponding hook and loop fasteners. Alternatively, the connectors and coupling feature may be in the form of snaps or any other suitable mechanisms for connection.

The connectors 26 of the strap 16 extend between a first connector end 30 and a second connector end 32. Preferably, the distance between the first connector end 30 and second connector end 32 correspond to the distance between the first end 22 and second end 24 of the back side 18.

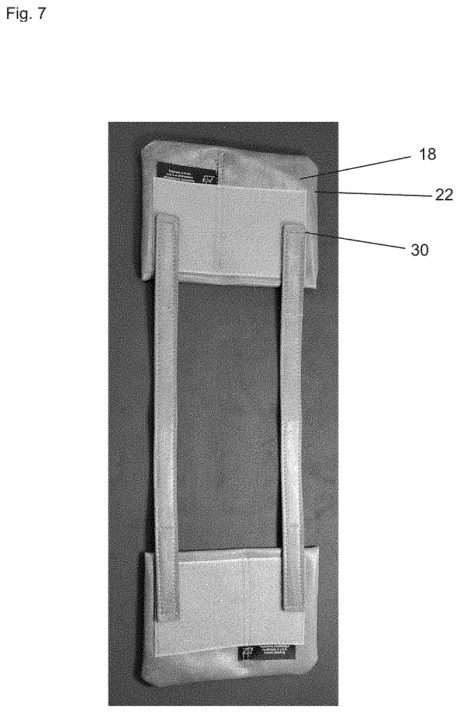

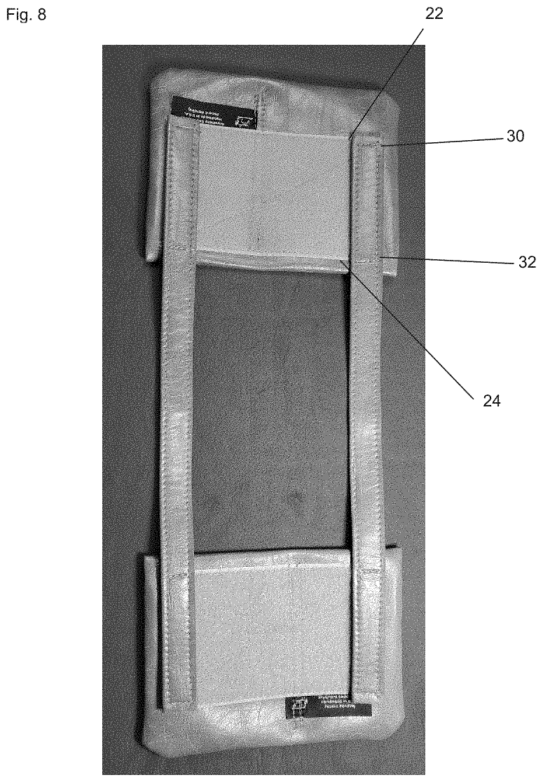

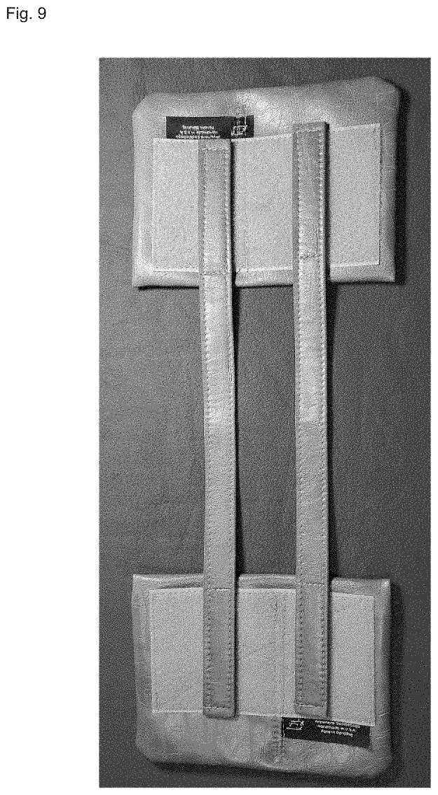

FIG. 7 depicts the straps 16 in an extended position where the first connector end 30 is not in contact with the first end 22 of the back side 18. FIG. 8 depicts the strap 16 positioned such that the first connector end 30 is aligned with the first end 22 and the second connector end 32 is aligned with the second end 24. FIG. 9 depicts the straps 16 in a narrowed configuration.

FIG. 5 through FIG. 12 depict the straps 16 connected to the coupling feature 20 of the back side 18 in variable positions of one or more panel members 10. The variability of the straps being connected to the coupling features contributes to the adjustability of the carrying device.

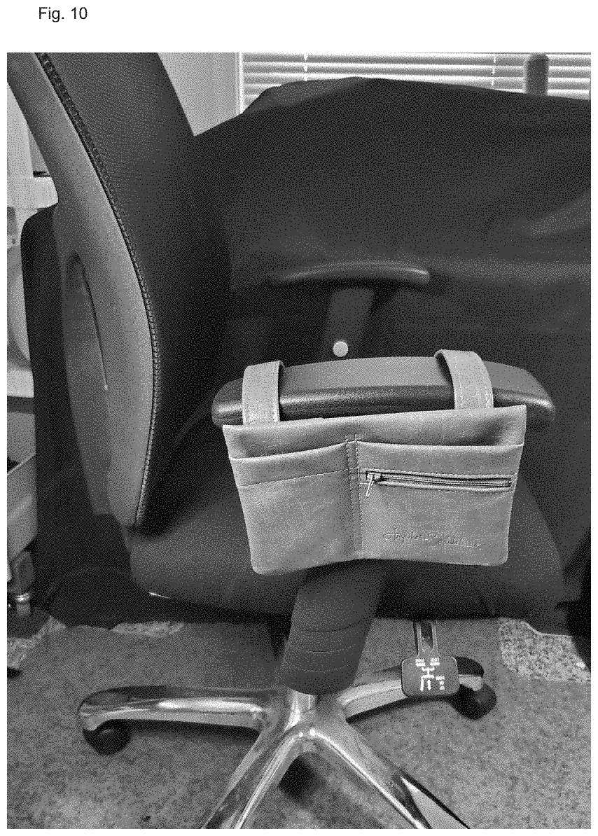

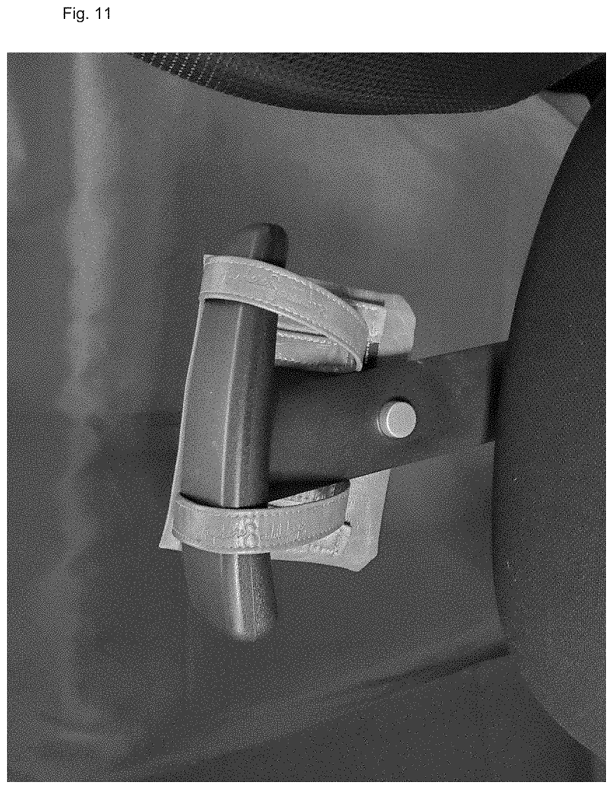

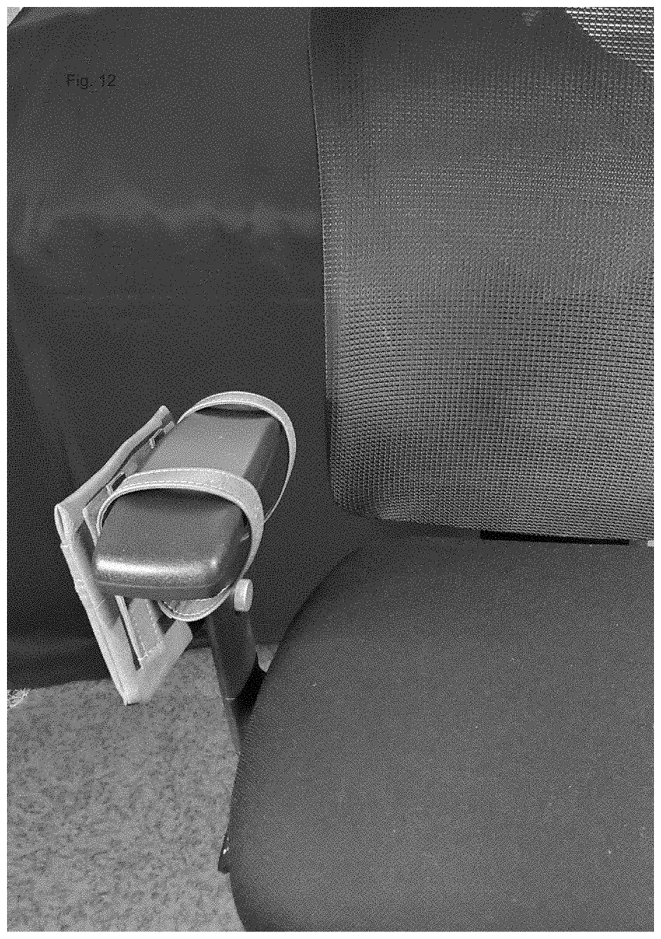

The customization of the modular carrying device allows a user to attach the carrying device to a desired object. As depicted in FIG. 10, a user may attach a carrying device 1 having a single panel member 10 to things such as the arm of an office chair. As depicted in FIGS. 11 and 12, to achieve this attachment the straps 16 are set in the looped configuration, as depicted in FIG. 5. A user may further customize the modular carrying device by attaching two panel members together and hanging them or otherwise placing them over an object. For instance, a carrying devices having two opposing panel members attached together via the straps may be hung over the center counsel of a vehicle. The modular carry device may be hung over other objects as well, such as on a bike or stroller or even an animal. In alternate embodiments, the modular carrying device may have more than two panel members connected together.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

I claim:

1. A modular carrying device comprising:
a first flexible panel member having a front side and back side, said first flexible panel member having at least one compartment configured for the storage of an item;
wherein said back side having a first end, a second end, a top end and a bottom end, wherein a coupling feature extends between said first end and second end;
a flexible strap comprising a first end and a second end and a length between said first end and said second end, wherein said first end and said second end comprise connectors positioned proximate to said first end and said second end, wherein said coupling feature and said connectors are configured for variable positioning of said flexible strap to said back side;
and wherein said flexible strap is removably attachable to said back side.

2. The modular carrying device of claim 1, wherein said compartment is an open pocket.

3. The modular carrying device of claim 2, wherein said open pocket is positioned on said front side of said panel member.

4. The modular carrying device of claim 1, wherein said compartment is a zippered compartment.

4. The modular carrying device of claim 4, wherein said zippered compartment is positioned on said front side of said panel member.

5. The modular carrying device of claim 1, wherein said front side has a plurality of compartments.

6. The modular carrying device of claim 5, wherein said plurality of compartments are positioned on said front side of said panel member.

7. The modular carrying device of claim 1, wherein said coupling feature of said back side is a panel of hook and loop fasteners configured for the removable attachment of said flexible strap, wherein said connectors of said flexible strap comprise corresponding hook and loop fasteners configured for attachment to said back side.

8. The modular carrying device of claim 7, wherein said flexible strap is removably attached to said back side through use of hook and loop fasteners.

9. The modular carrying device of claim 7, wherein said coupling feature of said back side is generally an elongate rectangular shape that spans the distance between said first end and said second end of said back side.

10. The modular carrying device of claim 1, further comprising a second panel member, wherein said first panel member and said second panel member are removably attached via said flexible strap.

11. The modular carrying device of claim 10, wherein said first panel member and second panel member are removably attached via at least two of said flexible straps.

12. The modular carrying device of claim 1 wherein said distance between said top end and said bottom end of said back side corresponds to said distance between said first connector end and said second connector end of said flexible strap.
